(19) United States
(12) Patent Application Publication
(10) Pub. No.: US 2014/0139058 A1
(43) Pub. Date: May 22, 2014

(54) STATOR STRUCTURE

(71) Applicant: INDUSTRIAL TECHNOLOGY RESEARCH INSTITUTE, Hsinchu (TW)

(72) Inventors: Tseng-Teh Wei, Hsinchu (TW); Huan-Lung Gu, Hualien County (TW); Li-Ju Cheng, Hsinchu (TW); Ming-Hung Lu, Hsinchu County (TW); Kou-Tzeng Lin, Hsinchu County (TW)

(73) Assignee: INDUSTRIAL TECHNOLOGY RESEARCH INSTITUTE, Hsinchu (TW)

(21) Appl. No.: 13/775,759

(22) Filed: Feb. 25, 2013

(30) Foreign Application Priority Data
Nov. 21, 2012 (TW) 101143579

(51) Int. Cl. H02K 5/20

(52) U.S. Cl. CPC H02K 5/20
USPC 310/59

(57) ABSTRACT

A stator structure includes a stator core, multiple windings and a frame. The stator core has multiple teeth and multiple grooves. The core has a first side and a second side opposite to each other. The teeth protrudes from the first side. The grooves are recessed inward from the second side. The windings are wound around the teeth respectively. A frame together with a plurity of cooling passages is cast to the grooves on the second side.

### CROSS-REFERENCE TO RELATED APPLICATIONS

This non-provisional application claims priority under 35 U.S.C. §119(a) on Patent Application No(s). 101143579 filed in Taiwan, R.O.C. on Nov. 21st, 2012, the entire contents of which are hereby incorporated by reference.

### TECHNICAL FIELD

The disclosure relates to a stator structure.

### BACKGROUND

In an existing stator structure, windings are generally wound around a stator core associated with a rotor to form a rotating device. The windings generate heat when electrified. When low electric power is applied on the windings, the heat generated by the windings and the stator core slightly raises the temperature of the windings. Such a temperature rise may not affect the insulating coating of the windings.

With the development of the electrical machines technology, the applications with higher rotating speed are gradually increase. Therefore, high electric power and high frequency must be applied on the windings to raise the rotating speed. However, the heat generated by the windings and the stator core is also increased, and the temperature of the windings rises significantly. Thereby, melting and deterioration of the insulating coating of the windings may occur, and further leads to a short circuit of the windings. The disposition of large cooling passages in the stator frame may impair the stiffness of the stator structure. This insufficient stiffness of the stator structure may also cause higher vibration and noise of the stator. Therefore, it is a problem to be solved to dissipate the heat generated by the windings and the stator core without affecting the stiffness of the stator structure.

### SUMMARY

In an embodiment, the disclosure provides a stator structure comprises a stator core, a plurality of windings and a frame. The stator core has a plurality of teeth and a plurality of grooves. The core has a first side and a second side opposite to each other. The teeth protrudes from the first side. The grooves are recessed inward from the second side. The windings are wound around the teeth respectively. A frame together with a plurity of cooling passages is cast to the grooves on the second side.

### BRIEF DESCRIPTION OF THE DRAWINGS

The disclosure will become more fully understood from the detailed description given herein below for illustration only, and thus does not limit of the disclosure, wherein:

FIG. 1 is a top view of a stator structure according to an embodiment of the disclosure;

FIG. 2A and FIG. 2B are side views of a fabrication process of the stator structure in FIG. 1;

FIG. 3A and FIG. 3B are partial top views of examples of constrained rings in the fabrication process of the stator structure in FIG. 1;

FIG. 4A and FIG. 4B are side cross-sectional views along cross-sections of cooling passages of a stator structure according to another embodiment of the disclosure;

FIG. 5 is a partial top view of a stator structure according to another embodiment of the disclosure;

FIG. 6 is a partial top view of a stator structure according to another embodiment of the disclosure; and

FIG. 7 is a partial top view of a stator structure according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

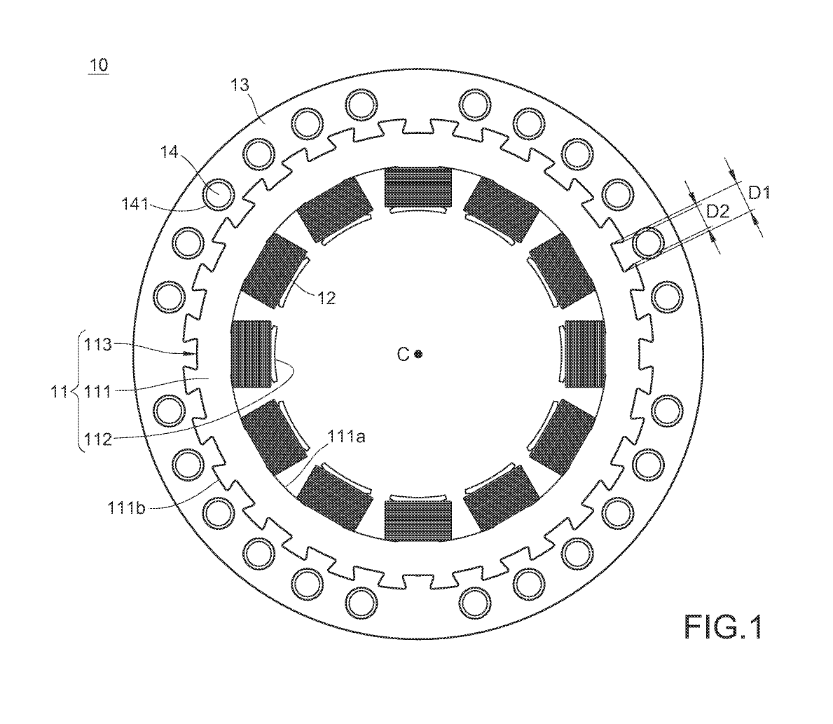

FIG. 1 is a top view of a stator structure 10 according to an embodiment of the disclosure. The stator structure 10 of the disclosure comprises a stator core 11, a plurality of windings 12 and a frame 13. The stator core 11 has a core 111, a plurality of teeth 112 and a plurality of grooves 113. The core 111 has a first side 111a and a second side 111b opposite to each other. The teeth 112 protrude from the first side 111a, and the grooves 113 are recessed inward from the second side 111b. The width D1 of the side of the groove 113 close to the core 111 is larger than the width D2 of the side away from the core 111. The grooves 113 have a plurality of section edges. The section edges of the grooves 113 are chamfered and form as rounded corners. The stator core 11 has an axle center C, and the teeth 112 face the axle center C. The windings 12 are wound around the teeth 112 respectively.

In this and some other embodiments, the melting point of the material of the stator core 11 is higher than the melting point of the material of the frame 13, so that the frame 13 is cast to the grooves 113 on the second side 111b. The frame 13 comprises a plurality of cooling passages 14. The stator structure 10 further comprises a plurality of pipes 141. The pipes 141 are respectively disposed in the cooling passages 14 and attached to the frame 13. In this and some other embodiments, the pipe 141 is made of a material different from the material of the frame 13. For example, the pipe 141 is made of a metal material, and the melting point of the pipe 141 is higher than the melting point of the frame 13. Since the width D1 of the side of the groove 113 close to the core 111 is larger than the width D2 of the side away from the core 111, the frame is retained by the groove 113 and fixed accordingly. Since the frame 13 is cast to the stator core 11, the frame 13, the pipes 141 and the stator core 11 are tightly joined to each other. Thereby, good thermal conduction effect and improving the structural stiffness of the stator structure 10 are attainable. Therefore, the heat generated by the windings 12 and the stator core 11 when electrified is configured for being easily conducted from the stator core 11 to the frame 13. In this and some other embodiments, the pipes 141 contact with the stator core 11, so that the heat generated by the windings 12 and the stator core 11 is configured for being conducted from the stator core 11 to the pipes 141. In this and some other embodiments, a cooling fluid flows in the pipes 141 to facilitate the dissipation of the heat generated by the windings 12 and the stator core 11. In other embodiments, the stator structure 10 does not have the pipes 141, and the cooling passages 14 are formed by using a mold when the frame 13 is cast, so that the cooling fluid directly flows in the cooling passages 14 formed in the frame 13. No heatsink fin is disposed on an external side of the frame 13, back against the axle center C, in the embodiment shown in FIG. 1, but the disclosure is not limited thereto. In other embodiments, heatsink fins are disposed on the external side of the frame 13, and are integrally formed with the frame 13. The heatsink fins are disposed to increase the heat dissipation area of the frame 13 and the structural stiffness of the stator structure 10.

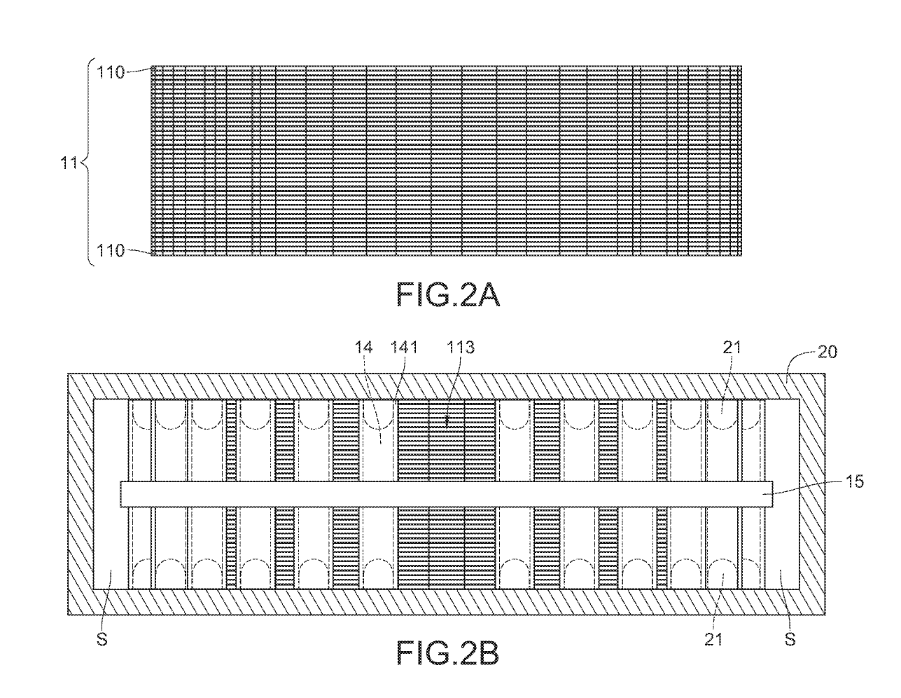

FIG. 2A and FIG. 2B are side views of a fabrication process of the stator structure 10 in FIG. 1. Referring to FIG. 2A, a plurality of laminations 110 is stacked to form the stator core 11. In this and some other embodiments, the laminations 110 are formed by stamping silicon steel plates. Referring to FIG. 2B, the pipes 141 are arranged on the periphery of the stator core 11 and fixed by a constrained ring 15. A mold 20 covers the stator core 11, the pipes 141 and the constrained ring 15. The mold 20 has a plurality of extenders 21 located at preset positions of the cooling passages 14. In this and some other embodiments, the extenders 21 are located in the pipes 141, so as to fix the pipes 141 through the mold and prevent the pipes 141 from tilting. The molten material of the frame 13 is filled in an empty cavity S between the mold 20 and the stator core 11. In this embodiment, the pipe 141 is a cylindrical straight pipe, but the disclosure is not limited thereto. In some other embodiments, the pipe 141 has other shapes.

Since the section edges of the grooves 113 of the stator core 11 are chamfered and form as rounded corners, the molten material of the frame 13 is successfully filled in the grooves 113, in order that the frame 13 is cast to the grooves 113. In this and some other embodiments, the constrained ring 15 functions as a stiffener of the frame 13, thereby enhancing the structural stiffness of the stator structure 10. In this embodiment, one constrained ring 15 is provided, but the disclosure is not limited thereto. In some other embodiments, a plurality of constrained rings 15 are provided. Since the frame 13 is cast to the stator core 11, a part of the material of the frame 13 permeates between the laminations 110, to increase the contact surface between the frame 13 and the stator core 11. Thereby, good thermal conduction effect is achieved.

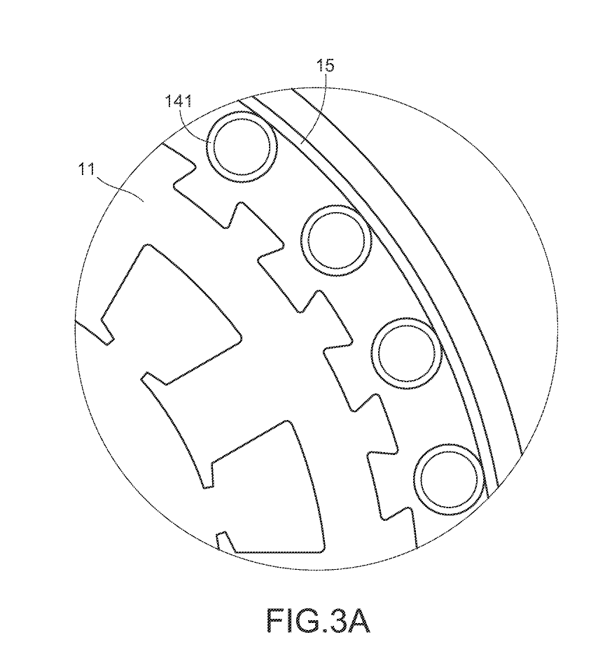

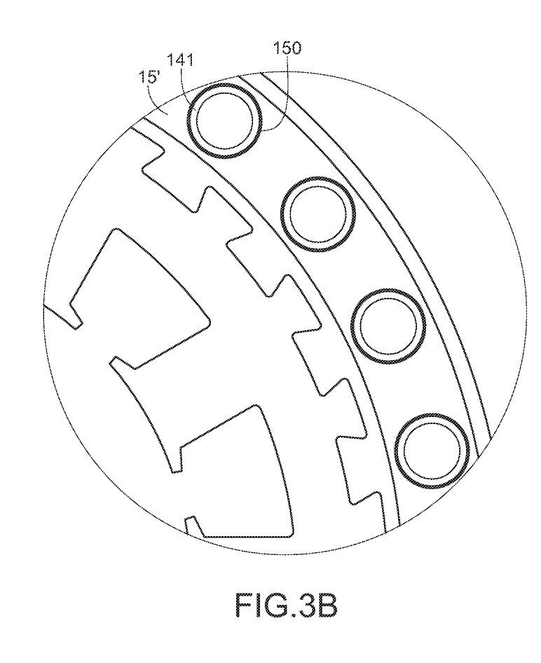

FIG. 3A and FIG. 3B are respectively partial top views of examples of constrained rings 15, 15′ in the fabrication process of the stator structure 10 in FIG. 1. Referring to FIG. 3A, the constrained ring 15 confines the pipes 141 from the outside, so that the pipes 141 are located between the constrained ring 15 and the stator core 11. Alternatively, referring to FIG. 3B, the constrained ring 15′ has a plurality of through-holes 150, and the pipes 141 are installed in the through-holes 150 of the constrained ring 15′ and are bounded by the constrained ring 15′.

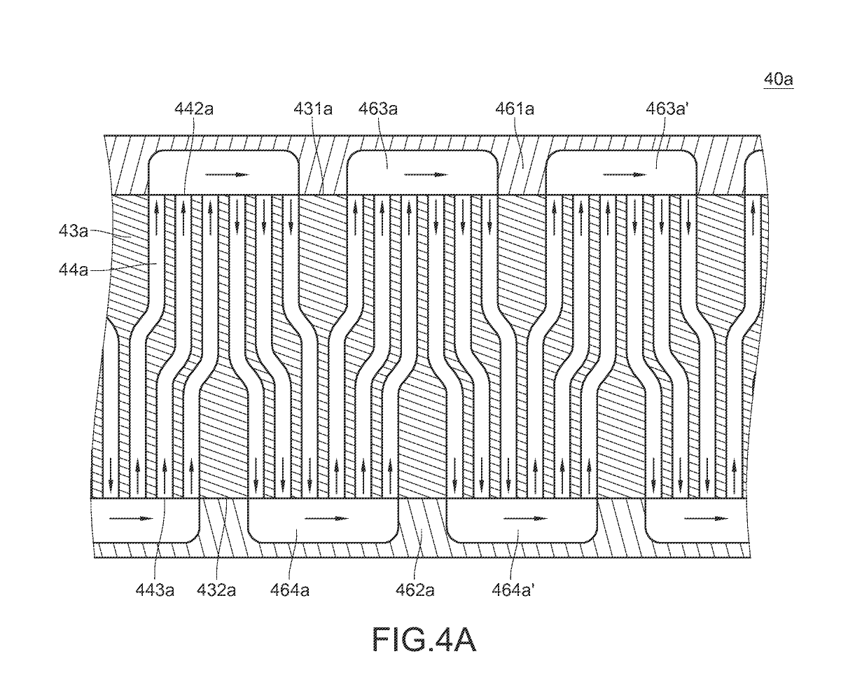

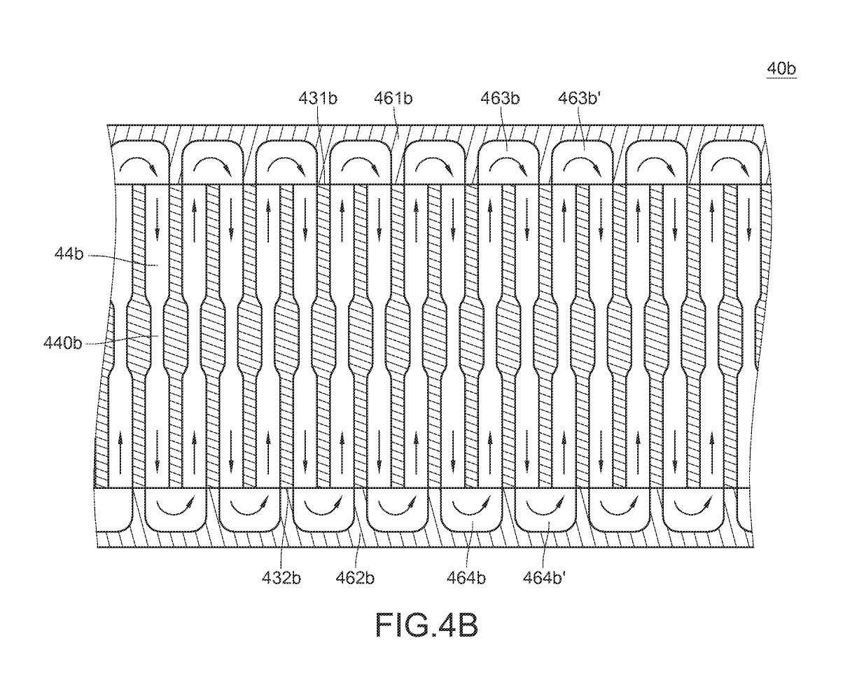

FIG. 4A and FIG. 4B are respectively side cross-sectional views along cross-sections of cooling passages 44a, 44b of the stator structures 40a, 40b according to another embodiment of the disclosure. In this embodiment, the stator structures 40a, 40b are similar to the stator structure 10 in FIG. 1, but have the cooling passages 44a, 44b of different shapes. Referring to FIG. 4A, the cooling passage 44a is in the shape of a curved pipe. The frame 43a of the stator structure 40a has two surfaces 431a, 432a at two opposite ends, and each cooling passage 44a has two openings 442a, 443a at two ends. The openings 442a, 443a are respectively located on the surfaces 431a, 432a. The stator structure 40a further comprises an upper cover and a lower cover 461a, 462a. The covers 461a, 462a are respectively disposed on the surfaces 431a, 432a. The covers 461a, 462arespectively have a plurality of interconnecting spaces 463a, 463a′, 464a, 464a′. The interconnecting spaces 463a, 463a′, 464a, 464a′ are configured for communicating the cooling passages 44a. In this and some other embodiments, the interconnecting spaces 463a, 463a′, 464a, 464a′ are configured for communicating the cooling passages 44a in a staggered manner. In this and some other embodiments, one interconnecting space 463a is configured for communicating six adjacent cooling passages 44a. The adjacent three of the six cooling passages 44a are configured for communicating one interconnecting space 464a, and the other three adjacent cooling passages 44a are configured for communicating another interconnecting space 464a′. In this and some other embodiments, one interconnecting space 464a′ is configured for communicating six adjacent cooling passages 44a. The adjacent three of the six cooling passages 44a are configured for communicating one interconnecting space 463a, and the other three adjacent cooling passages 44a are configured for communicating another interconnecting space 463a′. In other embodiments, the interconnecting spaces 463a, 463a′, 464a, 464a′ are configured for communicating different numbers of the cooling passages 44a.

Referring to FIG. 4B, the cooling passage 44b of the stator structure 40b has a Venturi tube structure 440b, the diameter of the Venturi tube structure 440b is reduced in the middle. The cooling fluid speeds up when passing through the Venturi tube structure 440b, so as to remove more heat through the Venturi tube structure 440b. In this and some other embodiments, the Venturi tube structure 440b is disposed in a part or all of the cooling passages 44b in the stator structure 40b. In this and some other embodiments, the Venturi tube structure 440b is disposed at any position of the cooling passage 44b. The stator structure 40b further comprises an upper cover and a lower cover 461b, 462b. The covers 461b, 462b are respectively disposed on surfaces 431b, 432b at two opposite ends of the frame 43a. The covers 461b, 462b respectively have a plurality of interconnecting spaces 463b, 463b′, 464b, 464b′. The interconnecting spaces 463b, 463b′, 464b, 464b′ are configured for communicating the cooling passages 44b. In this and some other embodiments, the interconnecting spaces 463b, 463b′, 464b, 464b′ are configured for communicating the cooling passages 44b in a staggered manner. In this and some other embodiments, one interconnecting space 463b is configured for communicating two adjacent cooling passages 44b. One of the two cooling passages 44b is configured for communicating one interconnecting space 464b, and the other cooling passage 44b is configured for communicating another interconnecting space 464b′. In this and some other embodiments, one interconnecting space 464b′ is configured for communicating two adjacent cooling passages 44b. One of the two cooling passages 44b is configured for communicating one interconnecting space 463b, and the other cooling passage 44b is configured for communicating another interconnecting space 463b′. In other embodiments, the interconnecting spaces 463b, 463b′, 464b, 464b′ are configured for communicating different numbers of the cooling passages 44b.

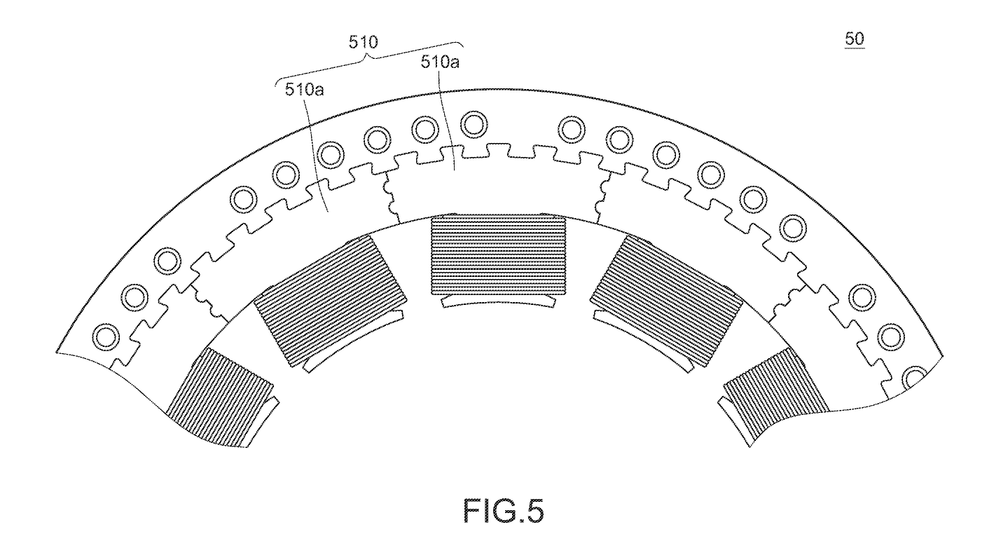

FIG. 5 is a partial top view of a stator structure 50 according to another embodiment of the disclosure. In this embodiment, the stator structure 50 is similar to the stator structure 10 in FIG. 1, but the core is built up from multi-layers of lamination 510. Each lamination 510 comprises a plurality of segmented laminations 510a. The segmented laminations 510a are laid next to each other to form a complete 360 degree lamination 510. Therefore, when a large-sized stator structure 50 is to be fabricated, a large-sized stamping apparatus is not required to stamp a large-sized lamination 510. In this embodiment, only a common stamping apparatus is required to stamp the segmented laminations 510a which are then laid next to each other to form a large-sized lamination 510. Thereby, the excessive cost of the large-sized stamping apparatus is avoidable.

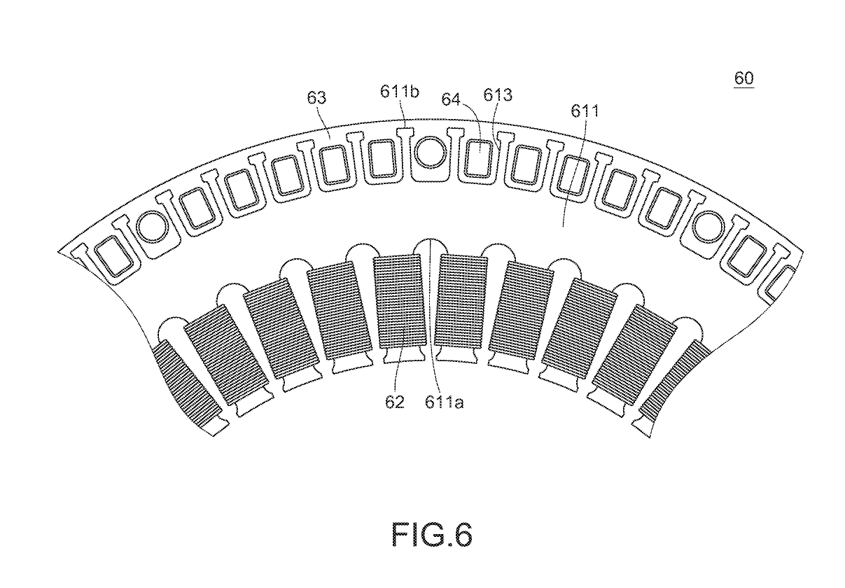

FIG. 6 is a partial top view of a stator structure 60 according to another embodiment of the disclosure. In this embodiment, the stator structure 60 is similar to the stator structure 10 in FIG. 1, but the cooling passages 64 are disposed in the grooves 613. In this embodiment, the groove 613 is U-shaped with a narrow opening and has the bottom of the U-shaped appearance are located on the core 611. Since the cooling passages 64 are disposed in the grooves 613, the heat generated by the windings 62 and the core 611 when electrified is transferred from the first side 611a to the second side 611b, and meanwhile transferred from the frame 63 to the cooling fluid in the cooling passages 64. Thereby, the heat dissipation efficiency is improved.

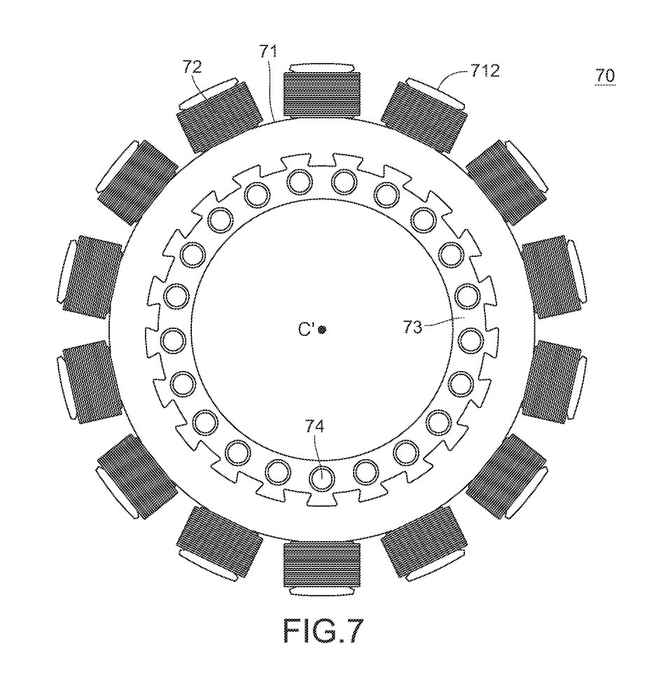

FIG. 7 is a partial top view of a stator structure 70 according to another embodiment of the disclosure. In this embodiment, the stator structure 70 is similar to the stator structure 10 in FIG. 1, but different from the teeth 112 in the stator structure 10, the teeth 712 are back against the axle center C′ of the stator core 71. Therefore, the teeth 712 and the windings 72 all face the external side of the stator structure 70. The heat generated by the windings 72 and the stator core 71 is transferred from the stator core 71 toward the axle center C′ and then removed from the stator structure 70 by the cooling passages 74. In this and some other embodiments, the stator core 71 is set to be hollow around the axle center C′, so that air passes through the axle center C′ to further dissipate heat. No heatsink fin is disposed on an internal side of the frame 73 facing the axle center C′ in the embodiment shown in FIG. 7, but the disclosure is not limited thereto. In other embodiments, heatsink fins are disposed on the internal side of the frame 73, and are integrally formed with the frame 73. The heatsink fins are disposed to increase the heat dissipation area of the frame 73 and the structural stiffness of the stator structure 70.

In view of the above, in the stator structure of the disclosure, the frame, cast to the grooves of the stator core, is tightly joined to the stator core in radial directions and circumferential tangential directions to achieve good thermal conduction effect and improve the structural stiffness. The heat generated by the windings and the stator core when electrified is well conducted from the stator core to the frame. A cooling fluid flows in the cooling passages of the frame to facilitate the dissipation of the heat generated by the windings and the stator core.

What is claimed is:

1. A stator structure, comprising:
a stator core having a core, a plurality of teeth and a plurality of grooves, the core having a first side and a second side opposite to each other, the teeth protruding from the first side, the grooves being recessed inward from the second side;
a plurality of windings wound around the teeth respectively; and
a frame, cast to the grooves on the second side, the frame comprises a plurality of cooling passages.

2. The stator structure according to claim 1, wherein the melting point of the material of the stator core is higher than the melting point of the material of the frame.

3. The stator structure according to claim 1, wherein the frame has two surfaces on two opposite ends, each cooling passage has two openings on two ends, and the two openings are respectively located on the two surfaces.

4. The stator structure according to claim 3, further comprising a plurality of covers, the covers being respectively disposed on the two surfaces at the two opposite ends of the frame.

5. The stator structure according to claim 4, wherein each cover has a interconnecting space, and the interconnecting spaces are configured for communicating the cooling passages.

6. The stator structure according to claim 1, wherein the stator core has an axle center, and the teeth face the axle center.

7. The stator structure according to claim 1, wherein the stator core has an axle center, and the teeth are back against the axle center.

8. The stator structure according to claim 1, wherein the stator core comprises a plurality of laminations stacked on each other.

9. The stator structure according to claim 8, wherein a part of the material of the frame permeates between the laminations.

10. The stator structure according to claim 8, wherein each lamination comprises a plurality of segmented laminations, and the segmented laminations are laid next to each other to form a complete 360 degree lamination.

11. The stator structure according to claim 1, wherein the cooling passages are disposed in the grooves.

12. The stator structure according to claim 1, wherein the widths of the sides of the grooves close to the core are larger than the widths of the sides of the grooves away from the core.

13. The stator structure according to claim 1, wherein the grooves are U-shaped with a narrow opening and the bottom of the U-shaped appearance are located on the core.

14. The stator structure according to claim 1, wherein the grooves have a plurality of section edges, the section edges of the grooves are chamfered and form as rounded corners.

15. The stator structure according to claim 1, wherein the cooling passage has a Venturi tube structure.

16. The stator structure according to claim 1, further comprising a plurality of pipes respectively disposed in the cooling passages and attached to the frame.

17. The stator structure according to claim 16, wherein the melting point of the material of each pipe is higher than the melting point of the material of the frame.

18. The stator structure according to claim 16, wherein each pipe is made of metal.

19. The stator structure according to claim 16, further comprising at least one constrained ring, the pipes being located between the constrained ring and the stator core.

20. The stator structure according to claim 16, further comprising at least one constrained ring, the pipes are installed in the constrained ring.
